(19) United States
(12) Patent Application Publication
(10) Pub. No.: US 2015/0295918 A1
(43) Pub. Date: Oct. 15, 2015

(54) USER AUTHENTICATION SYSTEM IN WEB MASH-UP CIRCUMSTANCE AND AUTHENTICATING METHOD THEREOF

(71) Applicant: Electronics and Telecommunications Research Institute, Daejeon (KR)

(72) Inventors: Jae Hoon NAH, Daejeon (KR); Sang Woo LEE, Daejeon (KR); Jung Chan NA, Daejeon (KR)

(21) Appl. No.: 14/666,992

(22) Filed: Mar. 24, 2015

(30) Foreign Application Priority Data
Apr. 9, 2014 (KR) 10-2014-0042275

(51) Int. Cl. H04L 29/06

(52) U.S. Cl. CPC H04L 63/0838; H04L 63/0853

(57) ABSTRACT

Disclosed is a user authenticating method in a web mash-up circumstance, including: requesting, by a mash-up server, updating an access authority token for accessing a data server to an authentication server; requesting, by the authentication server, a user authentication to the mash-up server; and issuing, by the authentication server, the updated access authority token to the mash-up server based on a response result to the user authentication request.

### CROSS-REFERENCE TO RELATED APPLICATIONS

This application claims priority to and the benefit of Korean Patent Application No. 10-2014-0042275 filed in the Korean Intellectual Property Office on Apr. 09, 2014, the entire contents of which are incorporated herein by reference.

### TECHNICAL FIELD

The present invention relates to a user authentication system in a web mash-up circumstance and an authenticating method thereof.

### BACKGROUND ART

In a web service circumstance, the same origin policy is a security concept which is important in a programming language for a browser, such as JavaScript. According to the same origin policy, an authority to access mutual methods and attributes is given to a script which is performed in a webpage caused by the same source (domain or site), but the access to the method and the attribute is not permitted in the case of pages of different sources (domains or sites).

This scheme plays a key role in preventing confidentiality or integrity of data from being lost by mutually exclusively managing access to contents (for example, data or codes) among different domains on an HTTP protocol. However, this scheme has a problem in preventing the contents having different domains from being used. In order to solve, OAuth 2.0 has been established as a standard (IETF in August 2013). However, the proposed standard is vulnerable to a man-in-the-middle on the Internet and in particular, has a problem in that the standard is vulnerable to a phishing attack. Furthermore, this scheme has a problem in a smishing attack due to convergence of a mash-up technique and a smart phone.

### SUMMARY OF THE INVENTION

The present invention has been made in an effort to provide a use authentication system in a web mash-up circumstance and an authenticating method thereof which can strengthen security against a phishing or smishing attack through a user authenticating process for a mash-up server.

The technical objects of the present invention are not limited to the aforementioned technical objects, and other technical objects, which are not mentioned above, will be apparent to those skilled in the art from the following description.

An exemplary embodiment of the present invention provides a user authenticating method in a web mash-up circumstance, including: requesting, by a mash-up server, updating an access authority token for accessing a data server to an authentication server; requesting, by the authentication server, a user authentication to the mash-up server; and issuing, by the authentication server, the updated access authority token to the mash-up server based on a response result to the user authentication request.

The user authentication may include an OTP authentication or CAPTCHA authentication.

In the issuing, by the authentication server, the updated access authority token to the mash-up server based on a response result to the user authentication request, when the user authentication is successful, the authentication server may issue the updated access authority token to the mash-up server.

In the issuing, by the authentication server, the updated access authority token to the mash-up server based on a response result to the user authentication request, when the user authentication is unsuccessful, the authentication server may not issue the updated access authority token to the mash-up server.

The method may further include receiving, by the authentication server, an authentication key corresponding to the user authentication request from the mash-up server.

In the issuing, by the authentication server, the updated access authority token to the mash-up server based on a response result to the user authentication request, when the authentication key matches a predetermined authentication key, the authentication server may issue the updated access authority token to the mash-up server.

The method may further include accessing, by the mash-up server, the data server by using the updated access authority token.

The requesting, by a mash-up server, updating an access authority token for accessing a data server to an authentication server may be performed according to a predetermined cycle.

Another exemplary embodiment of the present invention provides a user authentication system in a web mash-up circumstance including: a data server; an authentication server; and a mash-up server requesting updating an access authority token for accessing the data server to the authentication server and transmitting an authentication key input from a user to the authentication server in response to a user authentication request from the authentication server, and the authentication server may issue the updated access authority token to the mash-up server based on a response result of the mash-up server to the user authentication request.

The user authentication may include an OTP authentication or CAPTCHA authentication.

When the authentication key transferred from the mash-up server matches a predetermined authentication key, the authentication server may issue the updated access authority token to the mash-up server.

The mash-up server may access the data server by using the updated access authority token transferred from the authentication server.

The mash-up server may request updating the access authority token to the authentication server according to a predetermined cycle.

According to exemplary embodiments of the present invention, a user authentication system in a web mash-up circumstance and an authenticating method thereof can strengthen security against a phishing or smishing attack through a user authenticating process for a mash-up server.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a block diagram illustrating a user authentication system in a web mash-up circumstance according to an exemplary embodiment of the present invention.

FIG. 2 is a flowchart illustrating a user authenticating method in a web mash-up circumstance according to an exemplary embodiment of the present invention.

FIG. 3 is a swim lane diagram illustrating the user authenticating method in the web mash-up circumstance according to the exemplary embodiment of the present invention.

FIG. 4 is a swim lane diagram illustrating, in more detail, the user authenticating method in the web mash-up circumstance according to the exemplary embodiment of the present invention.

FIG. 5 is a block diagram illustrating a computing system that executes a user authenticating method in a web mash-up circumstance according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals refer to components of each drawing, it is to be noted that although the same components are illustrated in different drawings, the same components are referred to by the same reference numerals as possible. In describing the exemplary embodiments of the present invention, when it is determined that the detailed description of the known configuration or function related to the present invention may obscure the understanding of an exemplary embodiment of the present invention, the detailed description thereof will be omitted.

Terms such as first, second, A, B, (a), (b), and the like may be used in describing the components of the exemplary embodiments according to the present invention. The terms are only used to distinguish a constituent element from another constituent element, but nature or an order of the constituent element is not limited by the terms. Unless otherwise defined, all terms used herein including technological or scientific terms have the same meaning as those generally understood by a person with ordinary skill in the art to which the present invention pertains. Terms which are defined in a generally used dictionary should be interpreted to have the same meaning as the meaning in the context of the related art, and are not interpreted as an ideally or excessively formal meaning unless clearly defined in the present application.

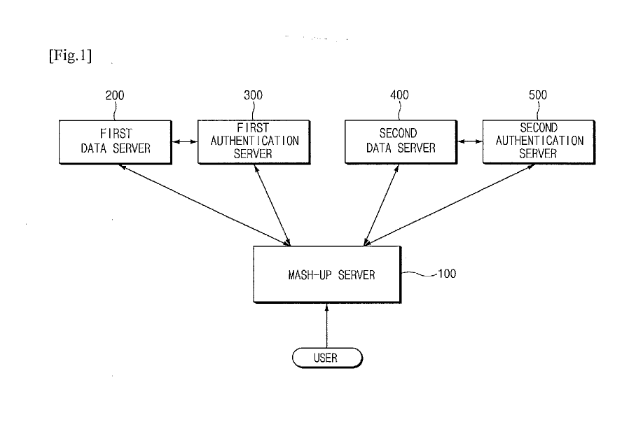

FIG. 1 is a block diagram illustrating a user authentication system in a web mash-up circumstance according to an exemplary embodiment of the present invention.

Referring to FIG. 1, the user authentication system in a web mash-up circumstance according to the exemplary embodiment of the present invention may include a mash-up server 100, a first data server 200, a first authentication server 300, a second data server 400, and a second authentication server 500.

The mash-up server 100 may request an authority authentication of a user to the first data server 200 and/or the second data server 400 in response to a request of the user. The mash-up server 100 may receive an authentication token from the first data server 200 and/or the second data server 400 based on an authority authentication result of the user.

The mash-up server 100 may request an access authority token for accessing the first data server 200 or the second data server 400 to the first authentication server 300 or the second authentication server 500, respectively by using the authentication token. For example, the mash-up server 100 may request the access authority token for accessing the first data server 200 to the first authentication server 300. Further, the mash-up server 100 may request the access authority token for accessing the second data server 400 to the second authentication server 500.

The mash-up server 100 may request required data by accessing the first data server 200 or the second data server 400 corresponding to the first authentication server 300 or the second authentication server 500, respectively by using the access authority token received from the first authentication server 300 or the second authentication server 500. For example, the mash-up server 100 may provide a service that receives information on the position of a store from the first data server 200 and traffic information from the second data server 400, respectively to display the information on a map and it will be fairly appreciated that the mash-up server 100 is not limited thereto.

The mash-up server 100 may request updating the access authority token to the first data server 300 and/or the second data server 400 according to a predetermined cycle. For example, the access authority token may be defined to be expired according to the predetermined cycle. The mash-up server 100 may be issued the updated access authority token from the first authentication server 300 or the second authentication server 500 and access the first data server 200 and/or the second data server 400 corresponding to the first authentication server 300 or the second authentication server 500, respectively by using the updated access authority token.

Each of the first data server 200 and the second data server 400 may store data and/or a code. The first data server 200 and the second data server 400 may request a user authentication to the first authentication server 300 or the second authentication server 500 corresponding thereto when a user authority authentication request is received from the mash-up server 100 and receive an authentication result. Each of the first data server 200 and the second data server 400 may transfer an authentication toke depending on the authentication result to the mash-up server 100.

Each of the first data server 200 and the second data server 400 may query validity of authentication of data requested to the first authentication server 300 or the second authentication server 500 corresponding thereto when a data request is received from the accessed mash-up server 100. For example, the query of the validity of the authentication may mean a query regarding whether the user has an authority to access the requested data.

Each of the first authentication server 300 or the second authentication server 500 may perform the user authentication in response to the user access authority access request received from the first data server 200 or the second data server 400. For example, the first authentication server 300 and the second authentication server 500 may perform the user authentication by requesting an account input to the user. When the user authentication is completed, each of the first authentication server 300 and the second authentication server 500 may transfer an authentication completion result to the corresponding first data server 200 or second data server 400. Further, the first authentication server 300 and the second authentication server 500 may receive a request for the access authority token from the mash-up server 100 and be issued the access authority token to the mash-up server 100 in response thereto.

Each of the first authentication server 300 and the second authentication server 500 may receive a request for updating the access authority token from the mash-up server 100. In this case, each of the first authentication server 300 and the second authentication server 500 may request the authentication of the user (that is, an operator or a manager of the mash-up server) to the mash-up server 100. For example, a one time password (OTP) authentication or a completely automated public turing test to tell computers and humans apart (CAPTCHA) authentication may be used as the user authentication.

For example, the OTP authentication may be defined as a user authentication scheme using a disposable password of a random number which is randomly generated. For example, the CAPTCHA may be defined as one kind of a program on the Internet, for example, a turing test (determination of a human or a program by considering a result by presenting a problem which the program is difficult to solve and it is easy for the human to solve) performed in order to prevent automatically attempting member joining by using a Bot-net.

Each of the first authentication server 300 and the second authentication server 500 may issue the updated access authority token to the mash-up server 100 based on the user authentication result. For example, each of the first authentication server 300 and the second authentication server 500 may issue the updated access authority token to the mash-up server 100 when the user authentication is successful. For example, each of the first authentication server 300 and the second authentication server 500 may not issue the updated access authority token to the mash-up server 100 when the user authentication is unsuccessful.

As described above, in the user authentication system in the web mash-up circumstance according to the exemplary embodiment of the present invention, when updating the access authority token is requested from the mash-up server 100, the authentication server 300 or 500 may request an authentication for the user (that is, the operator or the manager) of the mash-up server 100 and issue the updated access authority token to the mash-up server 100 according to an authentication result.

For example, when the mash-up server is infected or hacked with a malignant code before the mash-up server 100 requests updating the access authority token to the first authentication server 300 and/or the second authentication server 500, since the authentication server 300 or 500 performs the authentication of the user of the mash-up server 100 according to the present invention, the authentication server 300 or 500 may determine whether a main agent of the update request through the mash-up server 100 is a program such as a Bot or a user having an authentic authority. Accordingly, damage by a phishing or smishing attack due to the malignant code through the mash-up server 100 may be prevented.

Hereinafter, a user authentication method in a web mash-up circumstance according to an exemplary embodiment of the present invention will be described in detail with reference to FIG. 1. However, operations among the mash-up server 100, the first data server 200, and the first authentication server 300 will be primarily described for easy description.

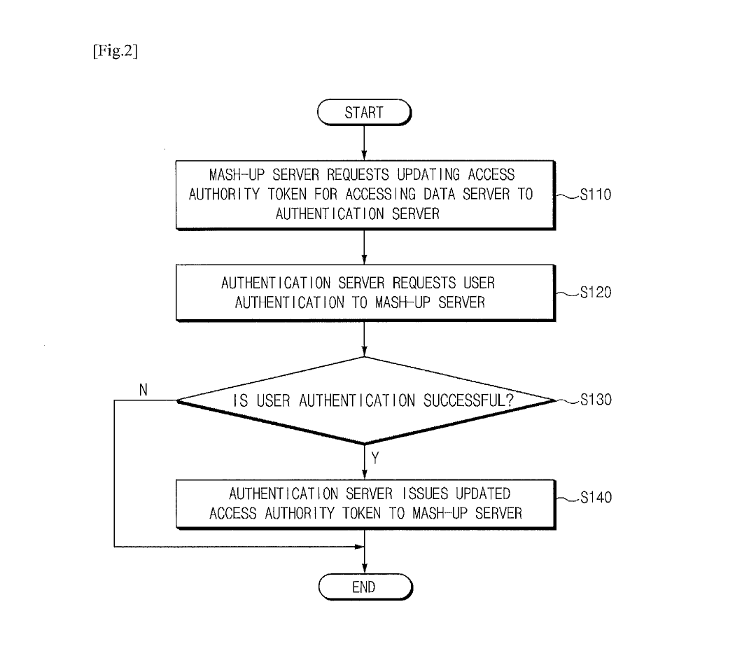

FIG. 2 is a flowchart illustrating a user authenticating method in a web mash-up circumstance according to an exemplary embodiment of the present invention.

Referring to FIG. 2, the user authenticating method in a web mash-up circumstance according to the exemplary embodiment of the present invention may include requesting, by a mash-up server, updating an access authority token for accessing a data server to an authentication server (S110), requesting, by the authentication server, a user authentication to the mash-up server (S120), determining whether to succeed in the user authentication (S130), and issuing, by the authentication server, an updated access authority token to the mash-up server based on a user authentication request result (S140).

Hereinafter, steps S110 to S140 described above will be described in detail with reference to FIG. 1.

In step S110, the mash-up server 100 may request an update of the access authority token to the authentication server 300. For example, the mash-up server 100 may request the update of the access authority token to the authentication server 300 according to a predetermined cycle (for example, an expiration cycle of the access authority token).

In step S120, the authentication server 300 may request the user authentication to the mash-up server 100. For example, the authentication server 300 may request the user authentication to the mash-up server 100 by using an OTP authentication or CAPTCHA authentication. For example, in the state where the mash-up server 100 is operated by the operator, when the mash-up server 100 requests the update of the access authority token to the authentication server 300, the aforementioned user authentication will be available. However, when the mash-up server 100 is infected with the malignant code or hacked and operated by the BOT, the aforementioned user authentication will be unavailable.

In step S130, the authentication server 300 may determine whether to succeed in the user authentication. For step S130, the method may further include receiving, by the authentication server 300, an authentication key corresponding to a user authentication request from the mash-up server 100. For example, in step S130, the authentication server 300 may determine that the user authentication is successful when the authentication key transferred from the mash-up server 100 matches a predetermined authentication key.

In step S140, the authentication server 300 may issue the updated access authority token to the mash-up server 100 when the user authentication is successful. On the contrary, the authentication server 300 will not issue the updated access authority token to the mash-up server 100 when the user authentication is unsuccessful.

Thereafter, the mash-up server 100 will access the data server 200 by using the updated access authority token.

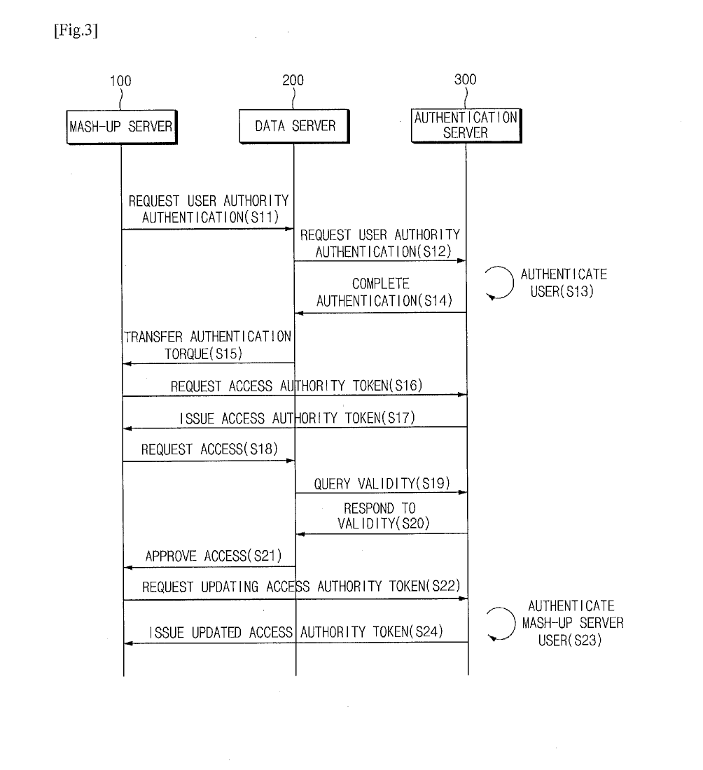

FIG. 3 is a swim lane diagram illustrating the user authenticating method in the web mash-up circumstance according to the exemplary embodiment of the present invention.

For example, FIG. 3 may be appreciated as a diagram illustrating an overall process in which the user authenticating method in the web mash-up circumstance according to the exemplary embodiment of the present invention is performed.

Referring to FIG. 3, the mash-up server 100 may request a user authority authentication to the data server 200 according to a request of the user (S11). The data server 200 may transfer a user authority authentication request to the authentication server 300 in response to the user authority authentication request from the mash-up server 100 (S12). The authentication server 300 may perform the user authentication (S13). In detail, the authentication server 300 may perform the user authentication by requesting an account input to the user. When the user authentication is completed, the authentication server 300 may transfer an authentication completion result to the data server 200 (S14). The data server 200 will transfer an authentication token to the mash-up server 100 (S15).

The mash-up server 100 may request an access authority token for accessing the data server 200, to the authentication server 300 by using the transferred authentication token (S16). The authentication server 300 may transfer the access authority token to the mash-up server 100 according to a request from the mash-up server 100 (S17).

The mash-up server 100 may request data by accessing the data server 200 with the access authority token (S18). The data server 200 may query validity of providing the data requested based on the access authority token to the authentication server 300 (S19). The authentication server 300 may review a predetermined policy according to the validity query and transfer a validity review result for the providing of the requested data to the data server 200 (S20). The data server 200 may provide the requested data to the mash-up server 100 when the providing of the requested data is valid (S21). The mash-up server 100 may request the update of the access authority token to the authentication server 300 according to a predetermined cycle (for example, an expiration cycle of the access authority token) (S22). The authentication server 300 may request the user authentication for the user (that is, the operator or manager) of the mash-up server 100 to the mash-up server 100 according to the request for updating the access authority token (S23). The authentication server 300 will issue the updated access authority token to the mash-up server 100 according to a user authentication result (S24).

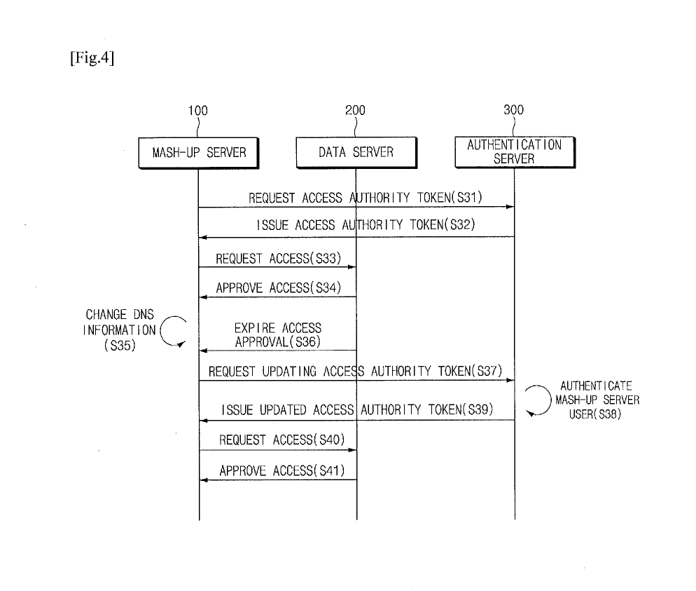

FIG. 4 is a swim lane diagram illustrating, in more detail, the user authenticating method in the web mash-up circumstance according to the exemplary embodiment of the present invention.

In FIG. 4, a difference from FIG. 3 will be primarily described in order to avoid unnecessary repetition of description.

Referring to FIG. 4, in the web mash-up circumstance, the mash-up server 100 may request accessing the data server 200 by using the access authority token issued from the authentication server 300 (S31, S32, and S33). The data server 200 may approve the access by reviewing the access authority token (S34).

Meanwhile, the mash-up server 100 is infected with the malignant code or hacked before requesting the update of the access authority token to the authentication server 300, and as a result, for example, DNA information may be changed (S35). In this case, the mash-up server 100 may be operated by a malignant program such as a Bot. Apart from this, when the access authority token is expired, the data server 200 may notify access approval expiration to the mash-up server 100 (S36).

According to the present invention, when the mash-up server 100 requests the update of the access authority token (S37), the authentication server 300 performs the authentication for the user of the mash-up server 100, and as a result, the authentication server 300 may determine whether a main agent of the update request through the mash-up server 100 is a program such as the Bot or a user having an authentic authority (S38). Accordingly, a phishing or smishing damage by the malignant code through the mash-up server 100 may be prevented.

When the mash-up server 100 is operated by the user having the authentic authority, the authentication server 300 may issue the updated access authority token to the mash-up server 100 (S39). The mash-up server 100 may request the access to the data server 200 by using the updated access authority token (S40) and receive the approval for the access request from the data server 200 (S41).

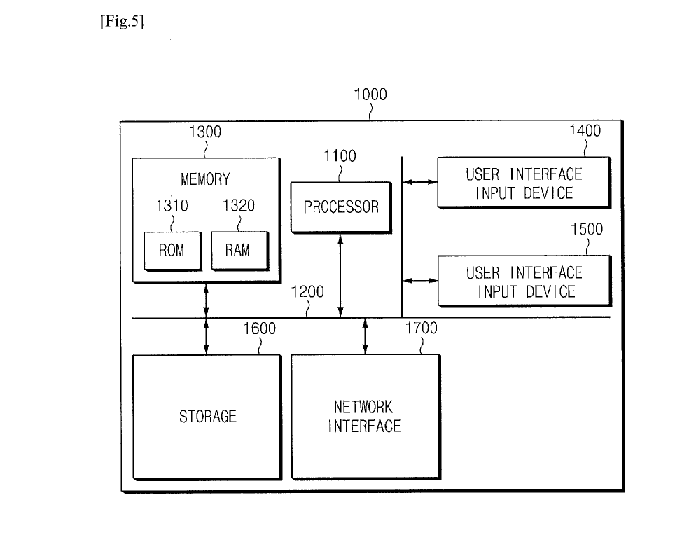

FIG. 5 is a block diagram illustrating a computing system that executes a user authenticating method in a web mash-up circumstance according to an exemplary embodiment of the present invention.

Referring to FIG. 5, the computer system 1000 may include one or more processors 1100 connected through a bus 1200, a memory 1300, a user interface input device 1400, a user interface output device 1500, a storage 1600, and a network interface 1700.

The processors 1100 may be a central processing unit (CPU) or a semiconductor device that processes commands stored in the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM.

The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal. As yet another method, the processor and the storage medium may reside in the user terminal as individual components.

The technical spirit of the present invention have been just exemplarily described in the above description, and various changes and modifications may be made by those skilled in the art to which the present invention pertains without departing from the intimate feature of the present invention.

Accordingly, the embodiments disclosed herein are intended not to limit but to describe the technical spirit of the present invention, and the scope of the technical spirit of the present invention is not limited to the embodiments. The scope of the present invention may be interpreted by the appended claims and all the technical spirits in the equivalent range thereto are intended to be embraced by the claims of the present invention.

What is claimed is:

1. A user authenticating method in a web mash-up circumstance, the method comprising:
requesting, by a mash-up server, an update of an access authority token for accessing a data server to an authentication server;
requesting, by the authentication server, a user authentication to the mash-up server; and
issuing, by the authentication server, the updated access authority token to the mash-up server based on a response result to the user authentication request.

2. The method of claim 1, wherein the user authentication includes an OTP authentication or CAPTCHA authentication.

3. The method of claim 2, wherein in the issuing, by the authentication server, the updated access authority token to the mash-up server based on a response result to the user authentication request,
when the user authentication is successful, the authentication sever issues the updated access authority token to the mash-up server.

4. The method of claim 2, wherein in the issuing, by the authentication server, the updated access authority token to the mash-up server based on a response result to the user authentication request,
when the user authentication is unsuccessful, the authentication server does not issue the updated access authority token to the mash-up server.

5. The method of claim 2, further comprising:
receiving, by the authentication server, an authentication key corresponding to the user authentication request from the mash-up server.

6. The method of claim 5, wherein in the issuing, by the authentication server, the updated access authority token to the mash-up server based on a response result to the user authentication request,
when the authentication key matches a predetermined authentication key, the authentication server issues the updated access authority token to the mash-up server.

7. The method of claim 1, further comprising:
accessing, by the mash-up server, the data server by using the updated access authority token.

8. The method of claim 1, wherein the requesting, by a mash-up server, an update of an access authority token for accessing a data server to an authentication server is performed according to a predetermined cycle.

9. A user authentication system in a web mash-up circumstance, the system comprising:
a data server;
an authentication server; and
a mash-up server requesting an update of an access authority token for accessing the data server to the authentication server and transmitting an authentication key input from a user to the authentication server in response to a user authentication request from the authentication server,
wherein the authentication server issues the updated access authority token to the mash-up server based on a response result of the mash-up server to the user authentication request.

10. The system of claim 9, wherein the user authentication includes an OTP authentication or CAPTCHA authentication.

11. The system of claim 10, wherein when the authentication key transferred from the mash-up server matches a predetermined authentication key, the authentication server issues the updated access authority token to the mash-up server.

12. The system of claim 9, wherein the mash-up server accesses the data server by using the updated access authority token transferred from the authentication server.

13. The system of claim 9, wherein the mash-up server requests an update of the access authority token to the authentication server according to a predetermined cycle.
